(19) United States
(12) Patent Application Publication
(10) Pub. No.: US 2019/0054371 A1
(43) Pub. Date: Feb. 21, 2019

(54) CONTROL OF A VIDEO DISPLAY HEADSET USING INPUT FROM SENSORS DISPOSED ABOUT THE BRAIN OF A USER

(71) Applicant: Lenovo Enterprise Solutions (Singapore) Pte. Ltd., Singapore (SG)

(72) Inventors: Jeffrey R. Hamilton, Pittsboro, NC (US); Ross L. Mickens, Cedar Grove, NC (US); Markesha F. Parker, Durham, NC (US)

(21) Appl. No.: 15/680,507

(22) Filed: Aug. 18, 2017

(51) Int. Cl. A63F 13/212; G06F 3/01; A63F 13/25; A63F 13/49

(52) U.S. Cl. CPC A63F 13/212; A63F 13/49; A63F 13/25; G06F 3/015

(57) ABSTRACT

An apparatus includes a headset with a display component securable to the head of a user for displaying video content to the user, a plurality of sensors securable about the head of the user for detecting electrical signals from the brain of the user, a storage device for storing program instructions of an application, and a processor for processing the program instructions. The processor processes the program instructions to output the video content to the display component, receive electrical signals from the sensors as the video content is output to the display component, compare the electrical signals with one or more predetermined electrical signal parameters that are correlated with the user taking a break from viewing the video content, and automatically alter the performance of the application in response to the electrical signals satisfying the one or more predetermined electrical signal parameters.

### BACKGROUND

The present disclosure relates to the control of a video display headset.

### Background of the Related Art

A video display headset is a device that may be secured to a user's head and includes a display that is positioned in the user's view. Such a headset may be commonly associated with virtual reality applications or augmented reality applications, but additional types of applications and information may be displayed using a headset. One popular use for a headset is the playing of video games, such as a virtual reality video game.

Video games generally, and especially virtual reality video games, may be very immersive for the user. The feeling that the user is within the game can cause the user to lose track of time and their surroundings. While this may be an indication that the game is well-designed and engaging or an indication that the user is enjoying the game, it can become a problem for the user over time if they neglect taking care of themselves.

### BRIEF SUMMARY

One embodiment provides an apparatus comprising a headset including a display component securable to the head of a user for displaying video content to the user, a plurality of sensors securable about the head of the user for detecting electrical signals from the brain of the user, at least one storage device for storing program instructions of an application, and at least one processor for processing the program instructions. The at least one processor is for processing the program instructions to output the video content to the display component of the headset, receive electrical signals detected by the plurality of sensors as the video content is output to the display component, compare the electrical signals received from one or more of the sensors with one or more predetermined electrical signal parameters that are correlated with the user taking a break from viewing the video content, and automatically alter the performance of the application in response to the electrical signals received from one or more of the sensors satisfying the one or more predetermined electrical signal parameters.

Another embodiment provides a computer program product comprising non-transitory computer readable storage media having program instructions of an application embodied therewith. The program instructions are executable by a processor to: output the video content to a display component of a headset securable to the head of a user, the display component for displaying video content to the user; receive electrical signals detected by a plurality of sensors as the video content is output to the display component, wherein the plurality of sensors are securable about the head of the user for detecting electrical signals from the brain of the user; compare the electrical signals received from one or more of the sensors with one or more predetermined electrical signal parameters that are correlated with the user taking a break from viewing the video content; and automatically alter the performance of the application in response to the electrical signals received from one or more of the sensors satisfying the one or more predetermined electrical signal parameters.

### BRIEF DESCRIPTION OF THE SEVERAL VIEWS OF THE DRAWINGS

FIG. 1 is a diagram of a system including a headset in communication with a computer that has access to a smart device cloud and an advertising service provider.

FIG. 2 is a diagram of a system similar to that in FIG. 1, except that the computer functionality is integrated into the headset.

FIG. 3 is an illustration of a headset including one or more straps for securing the headset and disposing various electrodes across a user's head.

FIG. 4 is a diagram of a generic smart device.

FIG. 5 is a diagram of various software functions or modules that may be used to implement brain monitoring and break history/logic.

FIG. 6 is a flowchart of a method according to one embodiment.

### DETAILED DESCRIPTION

One embodiment provides an apparatus comprising a headset including a display component securable to the head of a user for displaying video content to the user, a plurality of sensors securable about the head of the user for detecting electrical signals from the brain of the user, at least one storage device for storing program instructions of an application, and at least one processor for processing the program instructions. The at least one processor is for processing the program instructions to output the video content to the display component of the headset, receive electrical signals detected by the plurality of sensors as the video content is output to the display component, compare the electrical signals received from one or more of the sensors with one or more predetermined electrical signal parameters that are correlated with the user taking a break from viewing the video content, and automatically alter the performance of the application in response to the electrical signals received from one or more of the sensors satisfying the one or more predetermined electrical signal parameters.

A headset is a device that may be secured to a user's head and includes a display that is positioned in the user's view. In order to detect the user's brain signals, a plurality of sensors, such as electrodes, may be positioned to detect electrical impulses along the surface of one or more regions of the brain. The electrical signals emanating from each sensor are recorded so that the system can “machine learn” the user's behavior and patterns, so as to adjust the application dynamically in response to the electrical signals. The plurality of sensors may be conveniently secured to one or more straps that are used to secure the headset to the head of the user. Alternatively, the plurality of sensors may be secured to headphones or a dedicated sensor apparatus, which may be in the form of a cap.

Embodiments may determine when a user needs to eat or eliminate during an extended period of time engaged an application, such as a virtual reality application or an augmented reality application, which may be a video game. This determination may be based on brain signals detected by one or more of the sensors disposed in a position about the head of the user. The system may associate or correlate a user behavior with levels of certain brain signals detected by the sensors. Optionally, the system may provide content or messages to the user in response to detecting electrical signals that are associated with the user behavior. For example, brain signals may be associated with hunger or a need to eliminate, such that the system will output video content (one or more images) or an audible message suggesting that the user take a break from the application in order to address the user's needs. As a further example, if the brain signals are associated with hunger, the system may output an advertisement for a food product, where the advertisement may be a popup ad or an in-game advertisement or product placement.

The system may store a log or history identifying times when an application is paused indicating that the user is taking a break. The log or history may also store one or more brain signals of the user detected by the plurality of sensors as a function of time. Analysis of the historical data may identify brain signals or patterns that closely correlate with breaks that the user has taken. A correlation indicates that the previous detection of the identified brain signals, as indicated by the electrical signals received from the sensors, is frequently accompanied by a user break from the application, such that future occurrences of the electrical signals indicate that there is a high probability that the user needs to take a break. Accordingly, the electrical signals from the sensors may then be monitored and compared with predetermined electrical signals that are correlated with taking a break. In response to detecting electrical signals matching the predetermined electrical signals correlated with a user taking a break, the system may select and provide certain content to the user. The content should be selected to address a user behavior, such as a type of break taken, which is associated with the predetermined electrical signals.

In one option, the system may prompt a user to identify the nature of the break that the user is taking from the application. The user may reply to the prompt with voice input, text input or menu selection, without limitation, identifying the nature of the break. Alternatively, the system may detect the nature of the break through communication with one or more accessible smart devices, such as a smart refrigerator, smart toilet, activity tracker or other smart appliance or fixture. For example, the system may receive input from a smart device indicating user interaction. If the smart device communicates user interaction to the system immediately following a pause in the application, then the system may attribute the pause to the user's need for the identified user interaction with the smart device. Non-limiting examples of the user interaction may include flushing of a toilet, accessing a refrigerator, or taking a walk (measured by an activity tracker). Depending upon the type of the smart device, the user interaction may be detected or measured in various manners, such as refrigerator access being detected as opening of a refrigerator door, activation of an ice or beverage dispenser, or removal of a container or package. Removal of a container or package from a refrigerator might be detected using a camera and image recognition software or using an RFID reader to detect that a container or package has been removed.

By actively logging user brain signals and correlating those brain signals with user pauses in the application, the system may use those correlations along with currently detected brain signals to determine that the user needs to take a break, such as to certain eat, drink or eliminate. Preferably, the system will correlate brain signals with a particular type of break, such that the system can use brain signals to determine even the type of break that the user may need. In response to detecting brain signals indicating a need to take a break, the system may provide content suggesting the user take a break, provide content advertising a relevant food or drink product, or modifying the application settings or controls to encourage the user to take a break. For example, the system may increase or decrease the level of difficulty of the application so that a user may decide that it is a good time to take a break. Optionally, the system may further maintain a log indicating how a user responds to various levels of difficulty or other game features, such that the system may select and initiate a particular level of difficult or other game feature in order to encourage the user to take a break.

In accordance with the disclosed apparatus, the performance of the application may be automatically altered by the at least one processor further processing the program instructions to output additional video content to the display component of the headset. The additional video content may include an advertisement or a virtual object. Furthermore, the additional video content may prompt the user to take a break and to identify the nature of any break, the at least one processor further processing the program instructions to receive user input identifying the nature of the break. Alternatively, the performance of the application may be automatically altered by the at least one processor further processing the program instructions to automatically pause the application.

Embodiments of the apparatus may run various types of applications, but the application may optionally be a virtual reality application or an augmented reality application, which may be a video game. Optionally, the performance of the application may be automatically altered by the at least one processor further processing the program instructions to change one or more setting of the video game, such as a level of difficulty.

In one embodiment of the apparatus, the at least one processor may further process the program instructions to receive input each time the user takes a break from the application, collect a history of break records, each break record including the input received and the electrical signals received from the plurality of sensors during a time period that the input is received, determine one or more parameters of the received electrical signals that are correlated with the input, and store the one or more parameters as the one or more predetermined electrical signal parameters. These actions may allow the apparatus to learn how to determine when the user needs to take a break.

In one option, the input indicating that the user is taking a break is received from the user pausing the application. In another option, the input indicating that the user is taking a break may be a message received from a smart device indicating user activation of the smart device. For example, the smart device may be a smart toilet, wherein the user interaction includes flushing the smart toilet. As another example, the smart device may be a smart refrigerator, wherein the user interaction includes an action selected from the group consisting of opening a door to the refrigerator, activating an ice dispenser, activating a beverage dispenser, and removing a container from the refrigerator.

In one implementation, the smart device may be either a smart toilet or a smart refrigerator. Accordingly, the at least one processor may associate input from the smart toilet as a first type of break and associate input from the smart refrigerator as a second type of break. The processor may further store, for each break record in the history, the type of break, determine a first set of one or more parameters of the received electrical signals that are correlated with the first type of break, and determine a second set of one or more parameters of the received electrical signals that are correlated with the second type of break. Accordingly, each type of break is associated with a different set of parameters, such that a type of break needed by the user may be identified by the electrical signals received. Furthermore, the performance of the application may be automatically altered by the at least one processor further processing the program instructions to automatically alter the performance of the application in a first manner in response to the electrical signals received from one or more of the sensors satisfying the first set of one or more parameters, and automatically alter the performance of the application in a second manner in response to the electrical signals received from one or more of the sensors satisfying the second set of one or more parameters. The first manner of automatically altering the performance of the application may include the output of first additional video content to the display component of the headset, and the second manner of automatically altering the performance of the application may include the output of second additional video content to the display component of the headset. In this manner, video content may be customized to address the type of break that is needed by the user.

The electrical signals that are detected by the sensors may vary from one individual user to another individual user, such that the system may develop, maintain and use a separate correlation of brain signals and user behaviors for each user. For example, a user history may be associated with user login credentials or other authentication data, such that the system may modify the application in a manner that is customized the individual user's brain signals and break history.

A break of a certain nature may be referred to as an “event.” Optionally, the system may identify separate events for a food break, drink break, bathroom break, walking break, and other types of breaks. The electrical signals previously detected from the user's brain and correlated to an “event” may be referred to as an “event trigger.” An “event trigger” may be detected by a single sensor detecting an electrical signal exceeding a predetermined level, or may be a more complex set of conditions. For example, an event trigger may associated with electrical signals from multiple sensors meeting various criteria, such as each electrical signal meeting separate predetermined levels or matching certain predetermined patterns. The system may maintain an event database that stores multiple records, with each record identifying an event trigger for an event. If the system has multiple users, then one or more of the records may be specific to a given user.

Embodiments may continue to monitor brain signals over time in order to improve the accuracy of the correlations between event triggers and events, and improve the effectiveness of any messages, content or adjustments in application settings. For example, if current (i.e., recent) electrical signals from the sensors have satisfied a particular event database record but the user does not take a break within a given time period following the posting of a message suggesting a break, then the correlation between the event triggers (i.e., electrical signals) and event (i.e., a break) is weakened and the probability of the event trigger leading to the event is reduced. While it can be determined that the user does not take a break if the application does not experience a user-initiated pause and/or does not receive an activation signal from an accessible smart toilet, embodiments may determine that the user does not need a break in response to the user rejecting an in-application message prompting the user to take a break.

Another embodiment provides a computer program product comprising non-transitory computer readable storage media having program instructions of an application embodied therewith. The program instructions are executable by a processor to: output the video content to a display component of a headset securable to the head of a user, the display component for displaying video content to the user; receive electrical signals detected by a plurality of sensors as the video content is output to the display component, wherein the plurality of sensors are securable about the head of the user for detecting electrical signals from the brain of the user; compare the electrical signals received from one or more of the sensors with one or more predetermined electrical signal parameters that are correlated with the user taking a break from viewing the video content; and automatically alter the performance of the application in response to the electrical signals received from one or more of the sensors satisfying the one or more predetermined electrical signal parameters.

The foregoing computer program products may further include program instructions for implementing or initiating any one or more aspects of the methods or apparatus described herein. Accordingly, a separate description of the methods and apparatus will not be duplicated in the context of a computer program product.

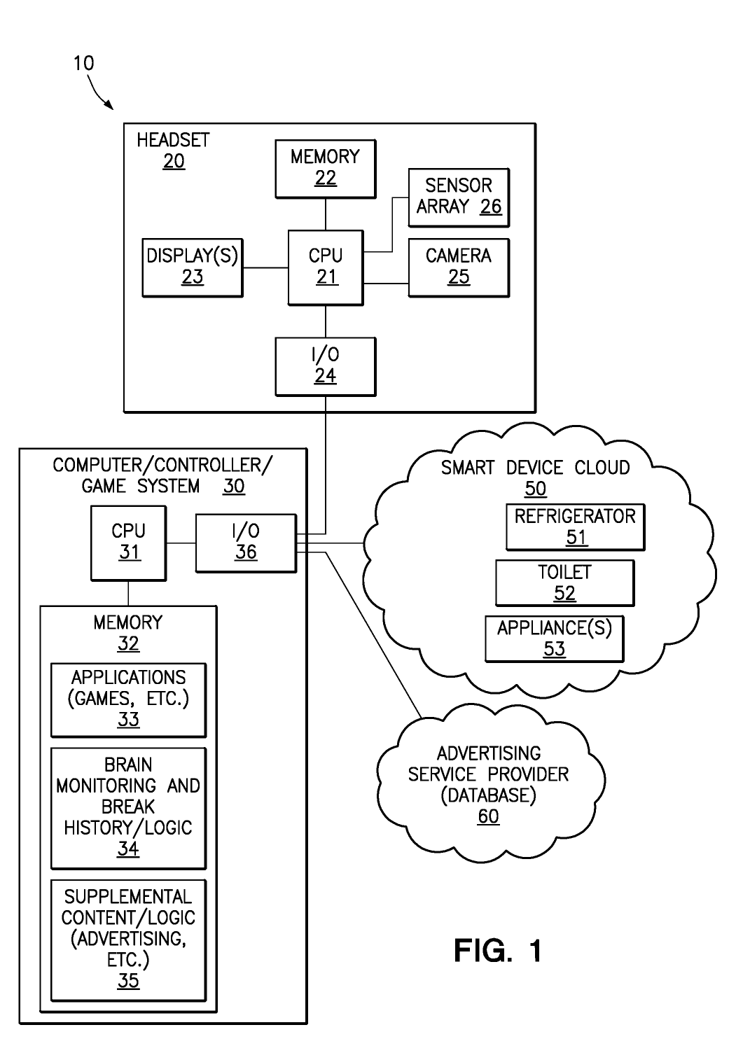

FIG. 1 is a diagram of a system 10 including a headset 20 in communication with a computer 30 that has access to a smart device cloud 50 and an advertising service provider 60. This system includes elements that allow implementation of various embodiments, but not all elements are necessary for each embodiment.

The headset 20 includes, without limitation, a central processing unit (CPU) 21 that communicates with memory 22, one or more displays 23, an input/output (I/O) adapter 24, a camera 25 and a sensor array 26. The memory 22 may store program instructions that are processed by the CPU 21 as well as data handled by the CPU 21. The one or more displays 23 receive video output from the CPU 21 and produce images that are viewable by a user wearing the headset 20. Some headsets may have a single display, while other headsets may have a separate display for each eye. Still other headsets may have further displays wrapping around a wide field of view. The I/O adapter 24 allows the CPU 21 to communicate with other devices, such as the computer, controller or game system 30.

The computer 30, which may also be referred to as a controller or game system, includes, without limitation, a central processing unit (CPU) 31, memory 32, and an input/output (I/O) adapter 36. The memory 32 may store program instructions that are processed by the CPU 31. Such program instructions may include various applications 33, brain monitoring and break history and logic 34, and supplemental content and logic 35. In certain embodiments, the applications may include a video game, and the supplemental content may include advertising. The I/O adapter 36 allows the CPU 31 to communicate with other devices, such as the headset 20.

The I/O adapter 36 may further allow the CPU 31 to communicate with various smart devices, which may collectively form a smart device cloud 50. For example, the smart devices may include a smart refrigerator 51, a smart toilet 52, or other smart appliances 53. In this context, the term “smart” means that the device includes capabilities that allow the device to detect one or more action or condition and to share the detected information with other devices. For example, a smart toilet 52 may detect movement of a handle or a drop in water level indicating that the user has flushed the toilet and may also transmit that user interaction with one or more other device, such as the computer 30. In another example, a smart refrigerator 51 may detect opening of a door to the refrigerator, activation of an ice dispenser, activation of a beverage dispenser, or removal a container from the refrigerator. The smart devices may include a wired or wireless transmitter or transceiver for communicating with one or more other devices using any of a variety of communication protocols, such as Bluetooth™ or Ethernet.

In certain embodiments, the I/O adapter 36 may further allow the CPU 31 to communicate with an advertising service provider 60, which may be a web server that includes a database of advertisements that can be provided to the CPU 31, perhaps as supplemental content 35, for provision in the application 33. For example, an embodiment may run an application 33, wherein the brain monitoring and break history/logic 34 determines that electrical signals received from the sensor array 26 indicate that the user needs to, or historically will, take a break. Accordingly, the supplemental content and logic 35 may provide content, such as video content and/or audio content, for insertion into the application 33 that is sending a video signal to the display 23 of the headset 30. In this manner, the advertising may be produced on the display 23 for viewing by the user, such that the user may be influenced to take a break. Such advertising may be as simply and overt as a popup window or as complex and subtle as a virtual object (i.e., product placement) inserted into a video game scene. For example, a beverage container may be added to a video game scene in response to determining that the user needs to take a break. In embodiments that distinguish brain signals indicating a user thirst, user hunger and user need for a bathroom, the advertisement is preferably customized to correspond to the type of break needed.

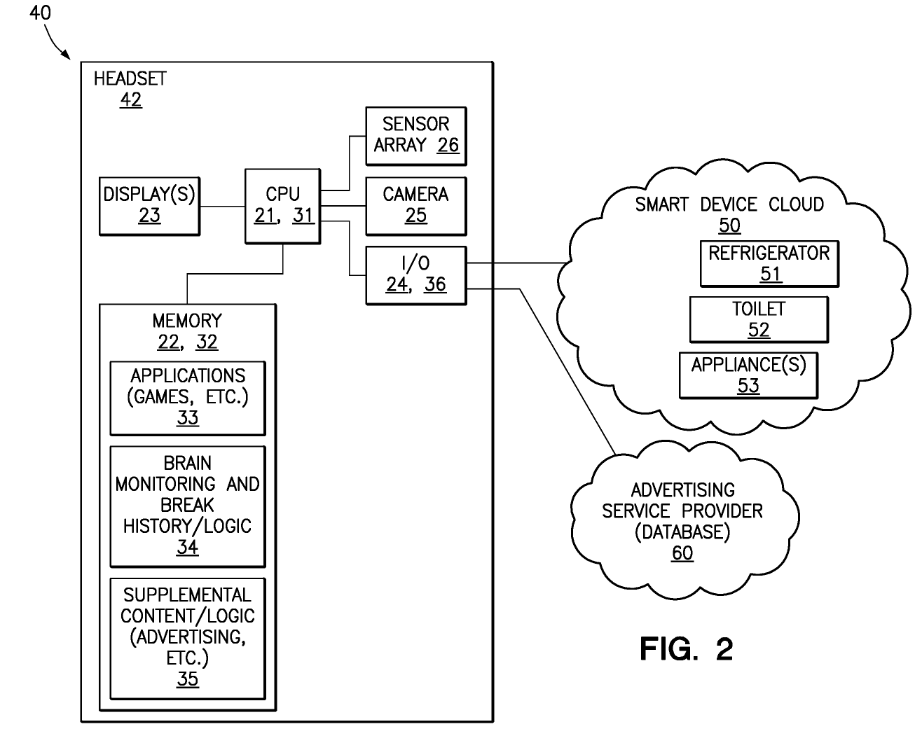

FIG. 2 is a diagram of a system 40 similar to that in FIG. 1, except that the functionality of the computer 30 and headset 20 from FIG. 1 is integrated into the headset 42. The headset 42, therefore, may operate as a stand-alone unit that runs its own applications without relying upon an external computer. Still, the headset 42 may communicate with any one or more smart device, such as those in the smart device cloud 50, and the advertising service provider 60.

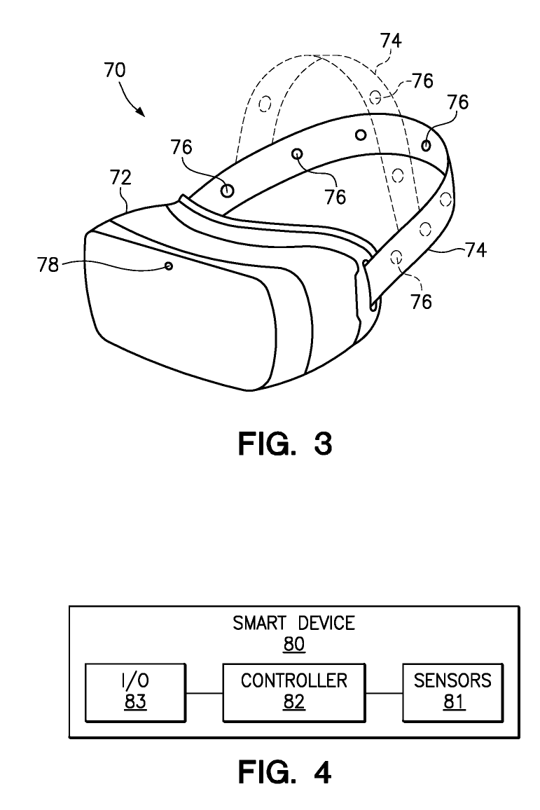

FIG. 3 is an illustration of a headset 70, such as the headset 20 of FIG. 1 or the headset 42 of FIG. 2, including a headset body 72 one or more straps 74 for securing the headset to a user's head and disposing various sensors (shown as circles) 76 across a user's head. The headset body 72 contains the CPU, display(s), and memory. An option camera 78 may also be part of the headset body, for example to facilitate a version of augmented reality. The sensors 76 will be in electronic communication with CPU (not shown) within the headset body 72, preferably by conductive wires (not show) run within or along the straps 74.

FIG. 4 is a diagram of a generic smart device 80, which may be a smart refrigerator, smart toilet or other smart appliance. While a smart device may include much more complexity and customized features, the smart device 80 includes one or more sensors 81, a controller 82 and an I/O device 83, such as a wireless transmitter. To implement a smart toilet, the smart device 80 may use a sensor 81 to detect actuation of the flush handle and the controller 82 to cause the I/O device 83 to transmit a message in response to a signal from the sensor 81 indicating user activation of the flush handle.

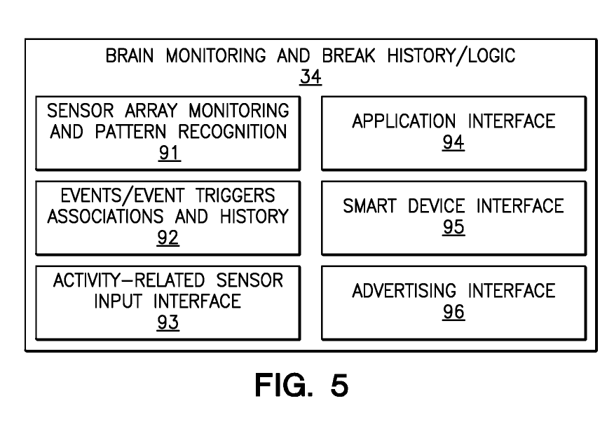

FIG. 5 is a diagram of various software functions or modules that may be used to implement brain monitoring and break history/logic 34. These functions or modules are provided for illustration only, and should be interpreted as being required to implement any particular embodiment disclosed herein.

A “sensor array monitoring and pattern recognition” module 91 may be provided to monitor the electrical signals received from any one or more of the plurality of sensors (sensor array 26 in FIGS. 1 and 2, or sensors 76 in FIG. 3). The module 91 may also be responsible for determining whether the electrical signals match predetermined parameters indicating that the user needs to take a break.

An “events/event triggers associations and history” module 92 may be provided to determine those predetermined parameters using a history of user breaks (events) and electrical signals (event triggers) received from one or more of the sensors. The module 92 uses the history of breaks and electrical signals to determine one or more parameter of the electrical signals that are correlated to a user taking a break.

An “activity-related sensor input interface” 93 may be provided to interface with one or more smart devices, for example to receive a message indicating user activity from an activity tracking device, such as a fitness watch. An “application interface” 94 may be provided to interface with an application, for example to provide video content to the application. A “smart device interface” 95 may be provided to interface with one or more smart device, for example to receive a message indicating user interaction with the smart device, such as a smart toilet or a smart refrigerator. An “advertising interface” 96 may be provided to interface with an off-site advertising server provider, for example to send information regarding the type of break that needs to be taken by the user and to receive advertisements selected on the basis of the type of the break. In one specific example, if the type of break is to eat food (i.e., satisfy hunger), then the advertisement should be selected to advertise a food product, such as a snack food or restaurant delivery service.

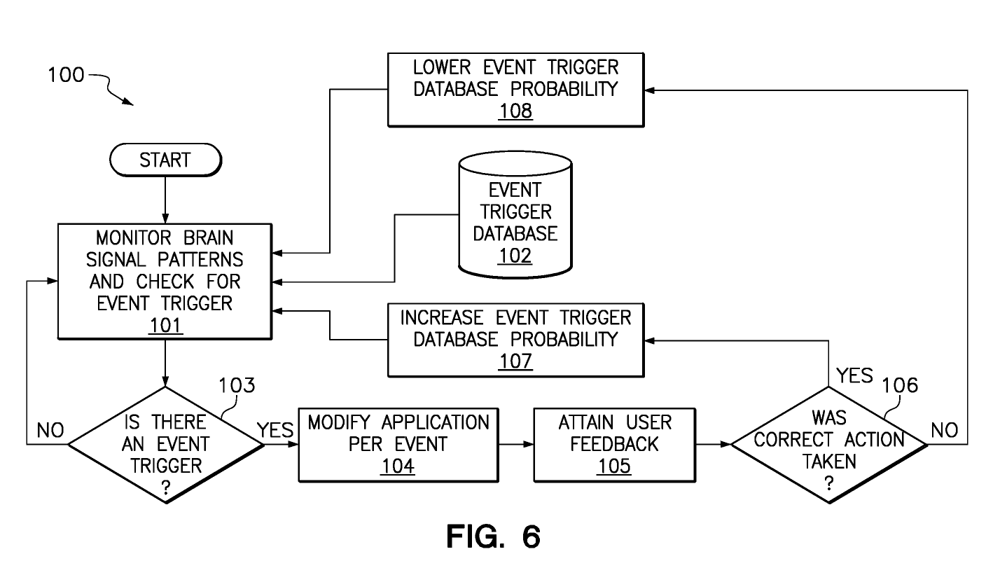

FIG. 6 is a flowchart of a method 100 according to one embodiment. Step 101 monitors brain signals patterns and checks for an event trigger, meaning that it is determined whether the electrical signals received from the sensors satisfy one or more predetermined parameter of electrical signals that indicate the user needs to take a break. The event trigger database is represented at element 102. Step 103 determines whether or not there is an event trigger. If there is no event trigger found, then the method returns to step 101. If an event trigger is found in step 103, then the method modifies the application (according to the nature of the event) in step 104 and attains user feedback in step 105. The application may modify the application by providing video (image) content to the application for inclusion in the video output to the headset. User feedback may include the user pausing the application, the user continuing the application, or the user interacting with a smart device that reports the user interaction to the system.

In step 106, the method determines whether the correct action was taken. In other words, if a break was indicated by the electrical signals satisfying the predetermined parameters, the method determines whether the user actually took a break upon being prompted according to one or more embodiment. If the correct action was taken (i.e., the user took a break as prompted), then step 107 increases the event trigger database probability (i.e., the correlation between the predetermined parameters and the user break is strengthened). However, if the correct action was not taken (i.e., the user did not take a break as prompted), the step 108 lowers the event trigger database probability (i.e., the correlation between the predetermined parameters and the user break is weakened).

As will be appreciated by one skilled in the art, embodiments may take the form of a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Any combination of one or more computer readable storage medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Furthermore, any program instruction or code that is embodied on such computer readable storage media (including forms referred to as volatile memory) that is not a transitory signal are, for the avoidance of doubt, considered “non-transitory”.

Program code embodied on a computer readable storage medium may be transmitted using any appropriate medium, including but not limited to wireless, wireline, optical fiber cable, RF, etc., or any suitable combination of the foregoing. Computer program code for carrying out various operations may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments may be described with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, and/or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored on computer readable storage media is not a transitory signal, such that the program instructions can direct a computer, other programmable data processing apparatus, or other devices to function in a particular manner, and such that the program instructions stored in the computer readable storage medium produce an article of manufacture.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to limit the scope of the claims. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the embodiment.

The corresponding structures, materials, acts, and equivalents of all means or steps plus function elements in the claims below are intended to include any structure, material, or act for performing the function in combination with other claimed elements as specifically claimed. Embodiments have been presented for purposes of illustration and description, but it is not intended to be exhaustive or limited to the embodiments in the form disclosed. Many modifications and variations will be apparent to those of ordinary skill in the art after reading this disclosure. The disclosed embodiments were chosen and described as non-limiting examples to enable others of ordinary skill in the art to understand these embodiments and other embodiments involving modifications suited to a particular implementation.

1. An apparatus, comprising:
a headset including a display component securable to the head of a user for displaying video content to the user;
a plurality of sensors securable about the head of the user for detecting electrical signals from the brain of the user;
at least one storage device for storing program instructions of an application; and
at least one processor for processing the program instructions to:
output the video content to the display component of the headset;
receive electrical signals detected by the plurality of sensors as the video content is output to the display component;
compare the electrical signals received from one or more of the sensors with one or more predetermined electrical signal parameters that are correlated with the user taking a break from viewing the video content; and
automatically alter the performance of the application in response to the electrical signals received from one or more of the sensors satisfying the one or more predetermined electrical signal parameters.

2. The apparatus of claim 1, wherein the performance of the application is automatically altered by the at least one processor further processing the program instructions to:
output additional video content to the display component of the headset.

3. The apparatus of claim 2, wherein the additional video content is selected from the group consisting of an advertisement and a virtual object.

4. The apparatus of claim 2, wherein the additional video content prompts the user to take a break and to identify the nature of any break, the at least one processor further processing the program instructions to:
receive user input identifying the nature of the break.

5. The apparatus of claim 1, the at least one processor for further processing the program instructions to:
receive input from a smart device indicating that the user has taken a break, wherein the smart device is selected from the group consisting of a smart toilet and a smart refrigerator.

6. The apparatus of claim 1, wherein the application is a video game.

7. The apparatus of claim 6, wherein the performance of the application is automatically altered by the at least one processor further processing the program instructions to:
change one or more setting of the video game.

8. The apparatus of claim 7, wherein the one or more setting of the video game is a level of difficulty.

9. The apparatus of claim 1, wherein the performance of the application is automatically altered by the at least one processor further processing the program instructions to:
automatically pause the application.

10. The apparatus of claim 1, wherein the application is selected from the group consisting of a virtual reality application and an augmented reality application.

11. The apparatus of claim 1, wherein the plurality of sensors are coupled to a strap that is used to secure the headset to the head of the user.

12. The apparatus of claim 1, the at least one processor for further processing the program instructions to:
receive input each time the user takes a break from the application;
collect a history of break records, each break record including the input received and the electrical signals received from the plurality of sensors during a time period that the input is received;
determine one or more parameters of the received electrical signals that are correlated with the input; and
store the one or more parameters as the one or more predetermined electrical signal parameters.

13. The apparatus of claim 12, wherein the input is received from the user pausing the application.

14. The apparatus of claim 12, wherein the input is a message received from a smart device indicating user activation of the smart device.

15. The apparatus of claim 14, wherein the smart device is a smart toilet and the user interaction includes flushing the smart toilet.

16. The apparatus of claim 14, wherein the smart device is a smart refrigerator and the user interaction includes an action selected from the group consisting of opening a door to the refrigerator, activating an ice dispenser, activating a beverage dispenser, and removing a container from the refrigerator.

17. The apparatus of claim 14, wherein the smart device is selected from the group consisting of a smart toilet and a smart refrigerator.

18. The apparatus of claim 17, the at least one processor further processing the program instructions to:
associate input from the smart toilet as a first type of break;
associate input from the smart refrigerator as a second type of break;
store, for each break record in the history, the type of break;
determine a first set of one or more parameters of the received electrical signals that are correlated with the first type of break; and
determine a second set of one or more parameters of the received electrical signals that are correlated with the second type of break;
wherein the performance of the application is automatically altered by the at least one processor further processing the program instructions to:
automatically altering the performance of the application in a first manner in response to the electrical signals received from one or more of the sensors satisfying the first set of one or more parameters; and
automatically altering the performance of the application in a second manner in response to the electrical signals received from one or more of the sensors satisfying the second set of one or more parameters.

19. The apparatus of claim 18, wherein the first manner of automatically altering the performance of the application includes the output of first additional video content to the display component of the headset, and wherein the second manner of automatically altering the performance of the application includes the output of second additional video content to the display component of the headset

20. A computer program product comprising non-transitory computer readable storage media having program instructions of an application embodied therewith, the program instructions executable by a processor to:
output the video content to a display component of a headset securable to the head of a user, the display component for displaying video content to the user;
receive electrical signals detected by a plurality of sensors as the video content is output to the display component, wherein the plurality of sensors are securable about the head of the user for detecting electrical signals from the brain of the user;
compare the electrical signals received from one or more of the sensors with one or more predetermined electrical signal parameters that are correlated with the user taking a break from viewing the video content; and
automatically alter the performance of the application in response to the electrical signals received from one or more of the sensors satisfying the one or more predetermined electrical signal parameters.
